(19) United States
(12) Patent Application Publication
(10) Pub. No.: US 2026/0141671 A1
(43) Pub. Date: May 21, 2026

(54) SYSTEM AND METHOD FOR BINARIZING IMAGES

(71) Applicant: Amrita Vishwa Vidyapeetham, Bengaluru (IN)

(72) Inventors: Remya Sivan, Bengaluru (IN); Peeta Basa Pati, Bengaluru (IN)

(21) Appl. No.: 19/202,300

(22) Filed: May 8, 2025

(30) Foreign Application Priority Data
Nov. 15, 2024 (IN) 202441088479

(51) Int. Cl. G06V 10/28; G06V 10/26; G06V 10/74; G06V 10/77

(52) U.S. Cl. CPC G06V 10/28; G06V 10/26; G06V 10/761; G06V 10/7715

(57) ABSTRACT

The present disclosure relates to a system (200) and a method (600) for binarizing one or more images using one or more vision transformers (206a, 206b). The system (200) includes an encoder (204) configured to receive multimodal inputs including an original image and a darkness image corresponding to the original image from an input module (202), discretely extract, by vision transformers (206a, 206b), modality-specific features from each of the original image and the darkness image, and aggregate augmenting features among the modality-specific features by determining a weighted sum of the modality-specific features of each of the original image and the darkness image. The system (200) includes a decoder (208) operatively connected to the encoder (204), and configured to reconstruct a binarized output image corresponding to the original image by refining the one or more aggregated features.

### TECHNICAL FIELD

The present disclosure relates to image processing, and more specifically, to a system and a method for binarizing images, particularly historical or degraded images.

### BACKGROUND

Binarization of images plays a vital role in document digitization, which involves converting physical documents into editable and searchable formats. This is crucial for preserving delicate historical documents that are deteriorating, ensuring that the historical documents remain accessible for future generations. Document digitization includes a series of subtasks, and binarization, to convert paper-based documents into readable and searchable formats accurately. These subtasks typically involve pre-processing 102, layout analysis 104, segmentation 106, and recognition 108, as illustrated in FIG. 1. All these subtasks are performed sequentially. Quality of the preceding subtask determines an effectiveness of the subsequent task. Pre-processing involves noise removal from the documents and binarizing the image. Layout analysis involves identifying a location of objects present in the document. Segmentation is a process of segmenting text part from the document and the segmented texts are recognized by the recognition module. This reduces complexity and storage needs, and improves tasks such as layout analysis, segmentation, and text recognition.

Binarization is an important pre-processing step during the document digitization, which reduces a complexity of the document image and storage requirement while enhancing readability. The historical documents often contain various forms of noise, such as stains, complex backgrounds, and ink bleeds. Binarization helps reduce the impact of these noises, enhances the contrast between the text and background, and makes the document more legible. However, the process of binarization is especially challenging when dealing with the historical documents.

M any techniques have been evolved to obviate the above-mentioned issues, and to binarize the document using traditional image processing techniques and deep learning methods. Both methods are effective for modern documents. However, these methods fail to yield good results when processing the historical documents. Binarization of the historical documents is a challenging task as they have complex backgrounds and the presence of noise in the document. These documents suffer from severe degradations like ink bleed-through, stains, and text fading. These degradations lead to a non-uniform background hence, thresholding-based binarization fails to binarize the historical documents. Handwritten historical documents present an additional challenge owing to text stroke width and colour variations. Due to these local variations, traditional morphological operations using fixed structuring elements are limited in their ability to binarize the historical documents. Edge-based segmentation also faces challenges in detecting the text boundary because of a low contrast between the text and the background. Historical papers, like palm leaf documents, worsen these challenges due to their document characteristics and the noise present in them.

Document binarization may be achieved using two main approaches. The first approach relies on statistical and structural features, while the second employs deep learning methods. Although the statistical and structural methods excel for the documents with minimal noise, they struggle to handle noise types effectively. On the other hand, the deep learning methods are proven to be more effective in diverse conditions of noise and other distortions, but they are computationally more expensive.

Therefore, there is, a need for an improved system to effectively perform document binarization, by overcoming at least the above-mentioned challenges, particularly for historical documents like palm leaves.

### SUMMARY

Aspects of the present disclosure relate to image processing, and more specifically, to a system and a method for binarizing images, particularly historical or degraded images.

In an aspect, the present disclosure relates to a system for binarizing one or more images using one or more vision transformers. The system includes an encoder operatively connected to an input module and configured to receive one or more multimodal inputs including at least an original image and a darkness image corresponding to the original image from the input module. The encoder is configured to discretely extract, by the one or more vision transformers associated with the encoder, one or more modality-specific features from each of the original image and the darkness image, and aggregate one or more augmenting features among the one or more modality-specific features by determining a weighted sum of the one or more modality-specific features of each of the original image and the darkness image. The system includes a decoder operatively connected to the encoder, and configured to reconstruct a binarized output image corresponding to the original image by refining the one or more aggregated features.

In an embodiment, the encoder may discretely extract the one or more modality-specific features from each of the one or more multimodal inputs by being configured to segment both the original image and the darkness image into one or more non-overlapping patches, transform the one or more non-overlapping patches into one or more feature vectors through patch embedding and positional embedding techniques, and discretely extract the one or more modality-specific features from the one or more feature vectors of each of the one or more multimodal inputs using a self-attention mechanism.

In an embodiment, the encoder may be configured to determine the weighted sum of the one or more modality-specific features based on one or more parameters.

In an embodiment, the encoder may aggregate the one or more augmenting features by being configured to dynamically balance an output of each of the original image and the darkness image from the one or more vision transformers through pre-trainable weights.

In an embodiment, the encoder may be configured to identify the one or more augmenting features among the one or more modality-specific features based on a dependency between the one or more non-overlapping patches.

In an embodiment, the encoder may determine the dependency between the one or more non-overlapping patches by being configured to transform each of the one or more non-overlapping patches into one or more variables, compare the one or more variables of each of the one or more non-overlapping patches, and determine the dependency between the one or more non-overlapping patches, based on a similarity score, to determine attention weights of each of the one or more non-overlapping patches.

In an embodiment, the encoder may be configured to determine a correlation between the one or more non-overlapping patches based on the similarity score and the attention weights of each of the one or more non-overlapping patches.

In an embodiment, the decoder may reconstruct the binarized output image corresponding to the original image by being configured to progressively transform the one or more feature vectors, through a combination of deconvolution, convolution, batch normalization, and activation techniques, to enhance spatial resolution and feature representation in one or more feature maps, upon transformation, dynamically enhance one or more regions with relevant information within the one or more feature maps to suppress one or more regions with irrelevant information within the one or more feature maps by applying a spatial attention mechanism, and reconstruct the binarized output image by further refining the one or more feature maps and the one or more aggregated features through the convolution techniques.

In an embodiment, the decoder may be configured to reconstruct the binarized output image with a predetermined spatial resolution.

In an aspect, the present disclosure relates to a method for binarizing one or more images using one or more vision transformers. The method includes receiving, by an encoder associated with a system, one or more multimodal inputs comprising at least an original image and a darkness image corresponding to the original image from an input module. The method includes discretely extracting, by the one or more vision transformers associated with the encoder, one or more modality-specific features from each of the original image and the darkness image. The method includes aggregating, by the encoder, one or more augmenting features among the one or more modality-specific features by determining a weighted sum of the one or more modality-specific features of each of the original image and the darkness image. The method includes reconstructing, by a decoder operatively connected to the encoder, a binarized output image corresponding to the original image by refining the one or more aggregated features.

Various objects, features, aspects, and advantages of the inventive subject matter will become more apparent from the following detailed description of preferred embodiments, along with the accompanying drawing figures in which like numerals represent components.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 illustrates an example block diagram 100 depicting a conventional document image digitization method.

FIG. 2 illustrates an exemplary architecture depicting a system 200 for binarizing one or more images using one or more vision transformers, in accordance with embodiments of the present disclosure.

FIG. 3 illustrates an example flow diagram 300 depicting a vision transformer architecture, in accordance with embodiments of the present disclosure.

FIG. 4A illustrates an exemplary architecture 400A of a decoder of the system, in accordance with embodiments of the present disclosure.

FIG. 4B illustrates a flow diagram 400B depicting a spatial attention mechanism on the decoder side, in accordance with embodiments of the present disclosure.

FIGS. 5A-5I illustrate a comparison of output images received from the system with Ground Truth (GT) images, in accordance with embodiments of the present disclosure.

FIG. 6 illustrates a flow chart of an example method for binarizing one or more images using one or more vision transformers, in accordance with embodiments of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosures as defined by the appended claims.

For the purpose of understanding of the principles of the present disclosure, reference will now be made to the various embodiments and specific language will be used to describe the same. It will nevertheless be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It will be understood by those skilled in the art that the foregoing general description and the following detailed description are explanatory of the present disclosure and are not intended to be restrictive thereof.

Whether or not a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more” or “one or more elements is required.”

Reference is made herein to some “embodiments.” It should be understood that an embodiment is an example of a possible implementation of any features and/or elements of the present disclosure. Some embodiments have been described for the purpose of explaining one or more of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment,” “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily betaken as limiting factors to the proposed disclosure.

The terms “comprise,” “comprising,” or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

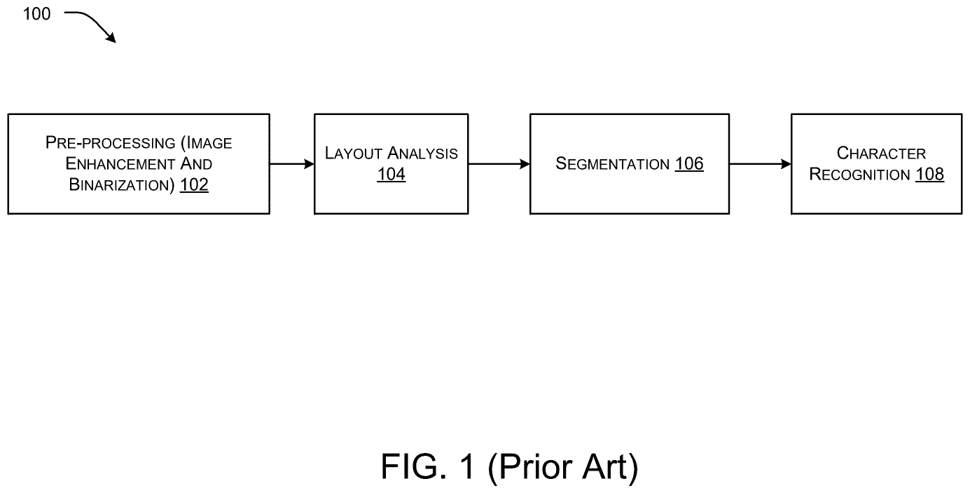

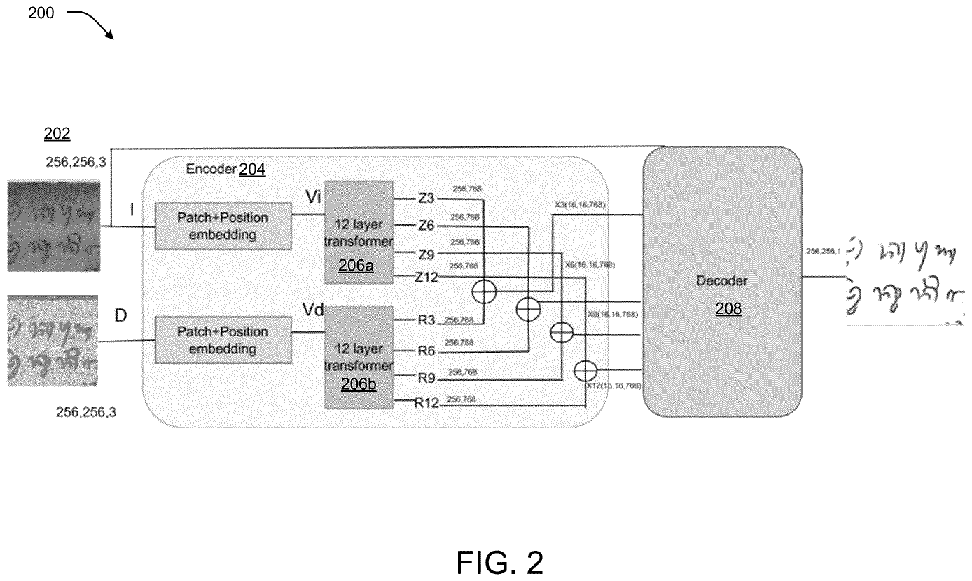

For the sake of clarity, the first digit of a reference numeral of each component of the present disclosure is indicative of the Figure number, in which the corresponding component is shown. For example, reference numerals starting with digit “1” are shown at least in FIG. 1. Similarly, reference numerals starting with digit “2” are shown at least in FIG. 2.

Embodiments of the present disclosure will be described below in detail with reference to the accompanying drawings. Embodiments of the present disclosure relate to image processing, and more specifically, to a system and a method for binarizing images, particularly historical or degraded images.

In an aspect, the present disclosure relates to a system for binarizing one or more images using one or more vision transformers. The system includes an encoder operatively connected to an input module and configured to receive one or more multimodal inputs including at least an original image and a darkness image corresponding to the original image from the input module. The encoder is configured to discretely extract, by the one or more vision transformers associated with the encoder, one or more modality-specific features from each of the original image and the darkness image, and aggregate one or more augmenting features among the one or more modality-specific features by determining a weighted sum of the one or more modality-specific features of each of the original image and the darkness image. The system includes a decoder operatively connected to the encoder, and configured to reconstruct a binarized output image corresponding to the original image by refining the one or more aggregated features.

In an aspect, the present disclosure relates to a method for binarizing one or more images using one or more vision transformers. The method includes receiving, by an encoder associated with a system, one or more multimodal inputs comprising at least an original image and a darkness image corresponding to the original image from an input module. The method includes discretely extracting, by the one or more vision transformers associated with the encoder, one or more modality-specific features from each of the original image and the darkness image. The method includes aggregating, by the encoder, one or more augmenting features among the one or more modality-specific features by determining a weighted sum of the one or more modality-specific features of each of the original image and the darkness image. The method includes reconstructing, by a decoder operatively connected to the encoder, a binarized output image corresponding to the original image by refining the one or more aggregated features.

Various embodiments of the present disclosure will be explained in detail with respect to FIGS. 2 to 6.

FIG. 2 illustrates an exemplary architecture depicting a system (200) for binarizing one or more images using one or more vision transformers (206a, 206b), in accordance with embodiments of the present disclosure.

With reference to FIG. 2, the system (200) may be configured for performing document binarization, for example, but not limited to, palm leaf document binarization. The system (200) may include an input module (202), an encoder (204), one or more vision transformers (206a, 206b), and a decoder (208).

In some embodiments, the input module (202) may be configured to feed one or more multimodal inputs into the encoder (204). The one or more multimodal inputs may include at least an original image and a darkness image corresponding to the original image. It may be appreciated that the darkness image may be interchangeably referred to as a relative darkness image corresponding to the original image. To enhance a performance and a robustness of the system (200), the relative darkness image is incorporated alongside the original image as input. In some embodiments, the encoder (204) may be operatively connected to the input module (202) and configured to receive the one or more multimodal inputs including the original image and the darkness image corresponding to the original image from the input module (202).

In some embodiments, the one or more vision transformers (206a, 206b) may be associated with the encoder (204), and configured with at least 12 layers to parallelly process the original image and the darkness image. In the field of image processing, each of the two input images, i.e., the original image and the darkness image are labelled as I and D, respectively, and represented with dimensions H×W×C, where H×W corresponds to the spatial resolution and C represents the input channels. I and D are transformed into feature vectors v_{I} and v_{D}, respectively, through a series of operations including patch embedding and positional embedding.

$${V}_{I} = PatchEmbedding ( I ) + PositionalEmbedding ( I ) \qquad ( 1 )$$

$${V}_{D} = PatchEmbedding ( D ) + PositionalEmbedding ( D ) \qquad ( 2 )$$

v_{I} and v_{D} may be generated from I and D by segmenting them into uniform non-overlapping patches. The number of patches per image, calculated as H×W/M×N. M×N may be the resolution of patches. Further, these 3 channel patches may be converted into 1D sequences for streamlined processing. Subsequently, linear projection may be employed on this 1D sequence, it reduces it to lower-dimensional vectors by multiplying each element of the 1D sequence by a weight and adding a bias to them. This weight and bias are learned during training time. Lower dimensionality may ensure less memory and computational resources. Furthermore, positional embedding may be added to each lower-dimensional 1D sequence to indicate the patch location in the image. These lower-dimensional vectors with the positional embedding may be fed to 12-layer transformer blocks, i.e., one or more vision transformers (206a, 206b).

The one or more vision transformers (206a, 206b) may be configured to discretely extract one or more modality-specific features from each of the original image and the darkness image. For example, the one or more modality-specific features extracted from the original image may include, but not limited to, a colour histogram, texture features, edges and gradients, key points and descriptors that represent local features of objects within the original image, object detection features, and the like. The one or more modality-specific features extracted from the relative darkness image may include, but not limited to, illumination-independent features, contrast-enhanced features, noise characteristics, dark object detection, pixel intensity, and saliency features identifying one or more regions that stand out even in dark conditions.

The one or more vision transformers (206a, 206b) may discretely extract the one or more modality-specific features from each of the one or more multimodal inputs by segmenting both the original image and the darkness image into one or more non-overlapping patches. The one or more non-overlapping patches may be transformed into one or more feature vectors through patch embedding and positional embedding techniques. Further, the one or more modality-specific features may be discretely extracted from the one or more feature vectors of each of the one or more multimodal inputs using a self-attention mechanism.

In some embodiments, the encoder (204) may be configured to dynamically balance an output of each of the original image and the darkness image from each of the one or more vision transformers (206a, 206b) through pre-trainable weights. The output may be dynamically balanced to aggregate one or more augmenting features among the one or more modality-specific features by determining a weighted sum of the one or more modality-specific features of each of the original image and the darkness image. The weighted sum of the one or more modality-specific features of each of the original image and the darkness image may be determined based on a reliability of each of the original image and the darkness image in different conditions. For example, more emphasis may be placed on edge features from the darkness image in low-light conditions and colour features from the original image in normal light.

In some embodiments, each of the one or more vision transformers (206a, 206b) may include a stack of self-attention layers and feed-forward networks to understand contextual information and dependency between the one or more non-overlapping patches. The self-attention layer may be configured to identify the one or more augmenting features among the one or more modality-specific features based on the dependency between the one or more non-overlapping patches. The self-attention layers of each of the one or more vision transformers (206a, 206b) may be configured to determine the dependency between the one or more non-overlapping patches by transforming each of the one or more non-overlapping patches into one or more variables. The one or more variables may be a query, a key, and a value, where the query is a feature of interest, the key is features that are relevant to the query, and the value is actual information present on the one or more non-overlapping patches. Further, the self-attention layers of each of the one or more vision transformers (206a, 206b) may be configured to compare the one or more variables of each of the one or more non-overlapping patches. For example, the self-attention layer may analyse each of the one or more non-overlapping patches and compares it to all other patches in the images. The self-attention layer may determine similarities between each patch's query and all other patches keys. A high similarity score may indicate that those patches are highly related.

In response to the comparison of the one or more variables of each of the one or more non-overlapping patches, the dependency between the one or more non-overlapping patches may be determined, based on a similarity score, to determine attention weights of each of the one or more non-overlapping patches. The self-attention layer may combine the value of the related patches based on their attention weights. The attention may be calculated as:

$$Attention ( Q , K , V ) = softmax ( \frac{{QK}^{T}}{\sqrt{{d}_{k}}} ) V \qquad ( 3 )$$

where, Q, K, V are the query, key, and value matrices.

Further, the feed-forward networks of the one or more vision transformers (206a, 206b) may be configured to determine a correlation between the one or more non-overlapping patches based on the similarity score and the attention weights of each of the one or more non-overlapping patches. That is, the feed-forward network may enable the system (200) to capture a complex relationship within the one or more non-overlapping patches. Layer normalization has been utilized to stabilize the training and reduce the training time of the system (200). Furthermore, skip connection may also be utilized to improve performance of the system (200) by propagating representation across layers. The original image and its corresponding relative darkness image may undergo independent encoder processing, adhering to the same architecture and steps. Skip connections may be strategically inserted at specific layers within each vision transformer (206a, 206b) to facilitate feature reuse and gradient flow.

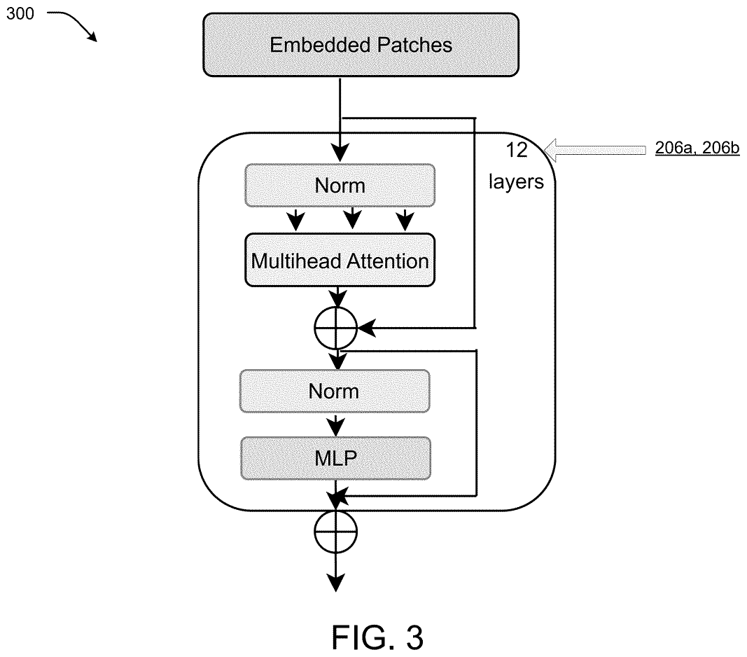

For example, as illustrated in FIG. 3 depicting a vision transformer architecture, each vision transformer (206a, 206b) may generate 12 layers of feature maps, each with a size of 256×768. From there, skip connections may be used to extract feature maps specifically from 3rd, 6th, 9th, and 12th layers with layer 3 being an upper layer and layer 12 being a lower layer. Subsequently, cross-pathway connections may allow the two pathways (vision transformers (206a, 206b)) to share information and take advantage of complementing or augmenting features from different modalities, i.e., the original image and the relative darkness image by using a weighted sum mechanism, where pre-trainable weights dynamically balance the contributions or the output from each pathway. The weighted sum x may be calculated as:

$$x = w . z + ( 1 - w ) . r \qquad ( 4 )$$

where, z is an output vector of the original image from the first vision transformer (206a), r is an output vector of the darkness image from the second vision transformer (206b), and w is the weight. The weight determines a proportion of the original image and the darkness image to form the x. The weight w is adjusted during training to minimize a loss function, effectively learning an optimal weighting for combining z and r. Additionally, reshaping techniques may assure feature dimension compatibility before combining, resulting in a complete method that improves image quality by using multiple modalities and facilitating information transmission across different pathways. Upon combining and reshaping the feature maps, the size of the images will be 16×16×768.

In some embodiments, the decoder (208) may be operatively connected to the encoder (204), and configured to reconstruct a binarized output image corresponding to the original image by refining the one or more aggregated features. The decoder (208) may be configured to reconstruct the binarized output image corresponding to the original image by progressively transforming the one or more feature vectors, through a combination of deconvolution, convolution, batch normalization, and activation techniques, to enhance spatial resolution and feature representation in one or more feature maps. Upon transformation, the decoder (208) may dynamically enhance one or more regions with relevant information within the one or more feature maps and suppress one or more regions with irrelevant information within the one or more feature maps by applying a spatial attention mechanism. The decoder (208) may reconstruct the binarized output image by further refining the one or more feature maps and the one or more aggregated features through the convolution techniques.

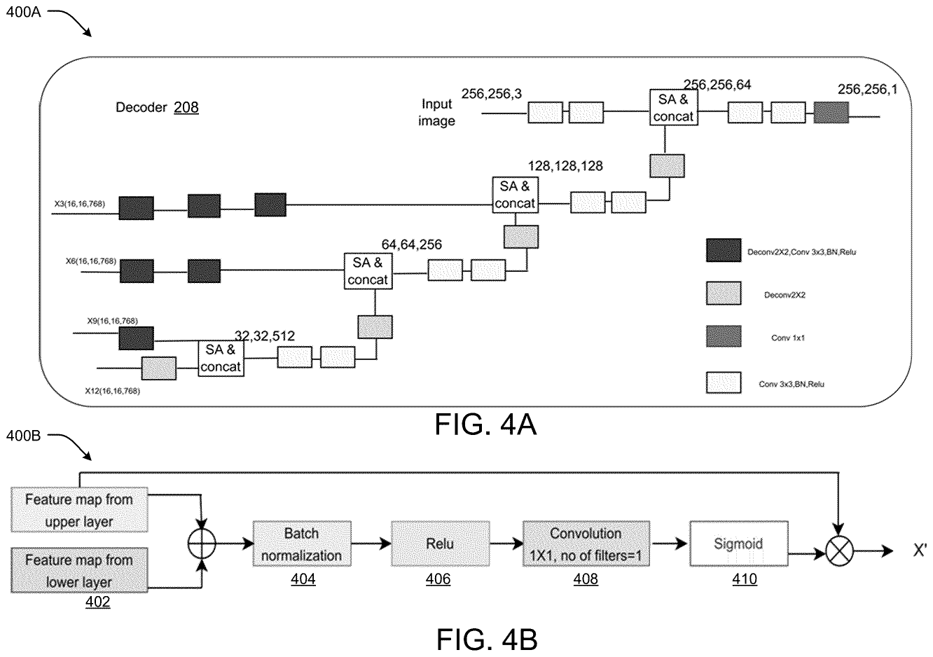

With reference to FIGS. 4A and 4B, FIG. 4A depicts an exemplary architecture (400A) of the decoder (208), and FIG. 4B depicts the spatial attention mechanism (400B) on the decoder (208) side. The decoder (208) may include a series of convolution and deconvolution blocks. The deconvolution blocks may be configured to reconstruct a segmentation mask from the learned feature maps. The convolution blocks may be utilized to refine the features (e.g., the one or more aggregated features) obtained from the previous layer (the self-attention layer and the feed-forward networks), and capture more detailed information. Furthermore, the decoder (208) may incorporate skip connections, concatenating feature maps from the encoder (204) and decoder blocks to fuse coarse and fine-grained information.

In addition, the decoder (208) may use spatial attention techniques to dynamically highlight important regions in the feature maps, enabling the system (200) to focus on relevant image features. The spatial attention mechanism may modulate (402) the feature map using the attention coefficient derived from the high-level features. The spatial attention mechanism is illustrated in FIG. 4B. The spatial attention is achieved through batch normalization (404), Rectified Linear Unit (ReLU) activation (406), convolution (408), and a sigmoid activation (410) to generate an attention map. This attention map may be then element-wise multiplied with the encoder's input, highlighting important spatial regions. Batch normalization may stabilize the training process, and the ReLU activation function may handle nonlinearity.

In addition, the output of the ReLU activation function may be used to generate attention coefficients through the application of sigmoid function. The upper layer traits may be subsequently modulated utilizing the attention coefficients.

The decoder (208) may include 4 feature-map up-sampling stages. Each stage may build upon the previous one to progressively refine the spatial details in the previous stage. As illustrated in FIG. 4A, for example, in the first stage, the feature map X 12 may undergo deconvolution to increase its spatial dimensions, resulting in an intermediate feature map with 512 channels. Simultaneously, feature map X 9 may undergo deconvolution followed by convolution, batch normalization, and ReLU activation to produce another intermediate feature map with 512 channels. A spatial attention gate may enhance salient features while suppressing irrelevant details. In the second stage, the feature map from the decoder (208) is deconvoluted to reduce channel dimensions to 256. Concurrently, the feature map X 6 may undergo deconvolution followed by convolution, batch normalization, and ReLU activation twice to yield another intermediate feature map with 256 channels. The subsequent processing mirrors that of the first stage.

In the third stage, the feature maps from the second stage may undergo deconvolution to reduce channel dimensions to 128. Simultaneously, feature map X 3 may undergo deconvolution followed by convolution, batch normalization, and ReLU activation three times to produce another intermediate feature map with 128 channels. In the fourth and final stage, the feature map from the third stage may be deconvoluted to reduce channel dimensions to 64. Feature map X 0 from the encoder (204) may undergo two convolution operations to refine spatial details. Spatial attention, concatenation, and two additional convolution operations may be employed to generate the final reconstructed output of 256×256×1.

Performance Result: Both qualitative and quantitative studies have been conducted to assess an efficacy of the system (200) on the chosen configuration from an ablation technique. Binarized images are quantitatively analysed by employing several evaluation metrics to assess the system's performance. Specifically, Peak Signal-to-Noise Ratio (PSNR), F-measure (FM), Negative Rate Metric (NRM), and Distance Reciprocal Distortion (DRD). Extensive experiments have been conducted with various chunk sizes to determine the optimal chunk and patch sizes for the proposed vision transformer model. By varying these parameters, it is aimed to identify the configurations that yield the best performance, ensuring that the proposed system (200) is both accurate and efficient in processing palm leaf images. Results are tabulated in Table 1. Table 1 depicts the system performance comparison for various images and patch sizes.

TABLE 1

| Image | Patch | Token | Token | | | | |
|---|---|---|---|---|---|---|---|
| Size | Size | Count | Dimension | FM | PSNR | NRM | DRD |
| 128 × 128 | 8 × 8 | 256 | 192 | 0.89 | 9.98 | 0.50 | 9.31 |
| 128 × 128 | 16 × 16 | 64 | 768 | 0.90 | 10.10 | 0.58 | 9.82 |
| 256 × 256 | 16 × 16 | 256 | 768 | 0.95 | 14.57 | 0.42 | 8.36 |
| 256 × 256 | 32 × 32 | 64 | 3072 | 0.91 | 10.8 | 0.51 | 9.10 |

It is observed that an image size of 256×256 and a patch size of 16×16 give better results. The combination of image size and patch size directly affects the input dimensions for the vision transforms, thereby influencing the system's effectiveness and performance. While the image size of 128×128 and the patch size of 8×8 capture detailed information, the smaller patch size results in the loss of some contextual details. On the other hand, with the patch size of 16×16, the higher token dimension can capture more context per token, and the significantly fewer number of tokens may lead to less accurate information capture. The combination of 16×16 patch size for a 256×256 image leads to more accurate information collection and can capture more context per token due to moderately sized tokens and larger token dimensions. On the other hand, with an image size of 256×256, the patch size of 8×8 and the patch size of 8×8 or 16×16 for the image size of 512×512, the computational complexity increases significantly due to a large number of tokens and large token dimensions. To get the best system performance, it is essential to strike the correct balance between the number and dimensions of tokens. The right balance guarantees that the system (200) may effectively handle computing resources and capture contextual and detailed information. The integration of relative darkness along with the image during the system training phase has significantly contributed to improving binarization accuracy.

To validate this, the experiment is repeated on the other dataset with and without relative darkness image and the results are shown in Table 2.

TABLE 2

| System | FM | PSNR | NRM |
|---|---|---|---|
| System using relative darkness | 0.87 | 10.31 | 0.48 |
| and spatial attention | | | |
| System without using relative | 0.65 | 6.47 | 0.67 |
| darkness of the image | | | |

From the reported result, it is clear that the system (200) using the relative darkness image gives good results across the dataset. These findings demonstrate how important extra features like the relative darkness of the image are in improving the system's flexibility and adaptability to different datasets, which results in better performance.

Further, the system (200) may be trained using different datasets to validate its generalization. The system (200) may be trained and tested on a variety of datasets, for example, but not limited to, Document Image Binarization Contest (DIBCO), Persian heritage image, and the like. Comparison of the proposed system (200) and conventional models is sown in Table 3.

TABLE 3

| Model | FM | PSNR | DRD |
|---|---|---|---|
| Proposed system without | 95.0 | 14.57 | 8.352 |
| controlled input chunks | | | |
| Proposed system with | 96.0 | 15.61 | 8.350 |
| controlled input chunks | | | |
| Conventional Model 1 | 68.27 | 14.81 | 8.940 |
| Conventional Model 2 | 69.65 | — | — |

The comparison results show that the proposed system (200) outperforms in handling different types of chunks, even those with different border properties. However, its PSNR is slightly lower than that of the conventional model. However, the experiment is repeated using the dataset creation approach proposed by the conventional model to ensure a robust comparison between the two methods. This allowed for a direct comparison of the proposed system's performance with the existing method under identical conditions. Specifically, in scenarios where chunk borders are clean and well-defined, the proposed system (200) outperforms the conventional model with a higher PSNR value, underscoring its superior performance in these controlled settings.

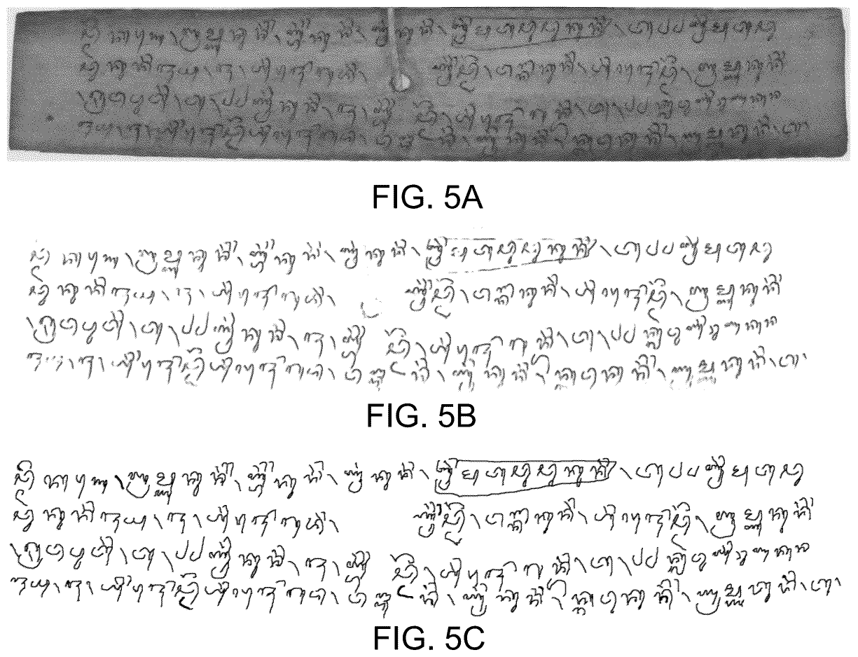

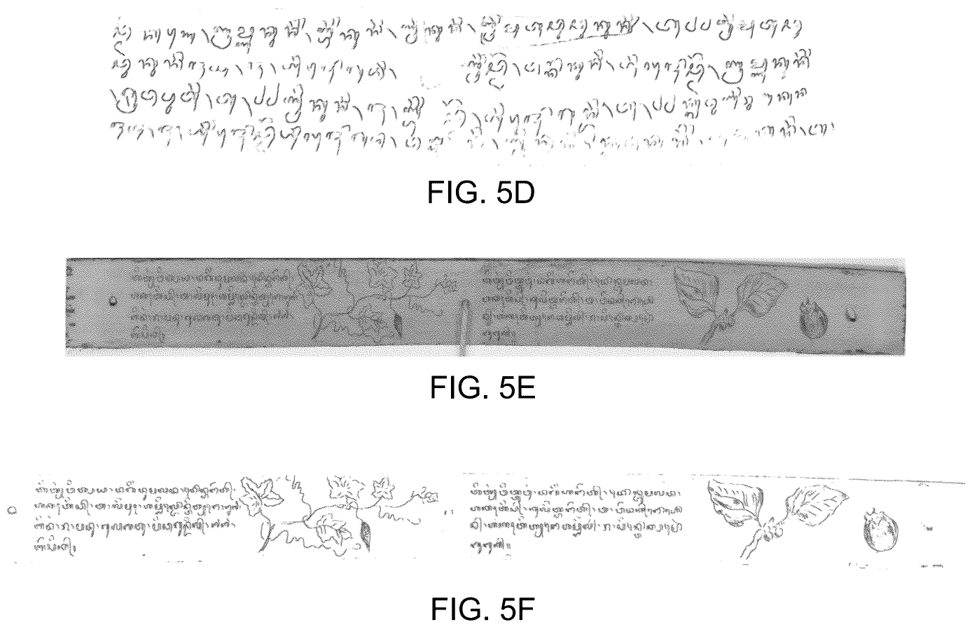

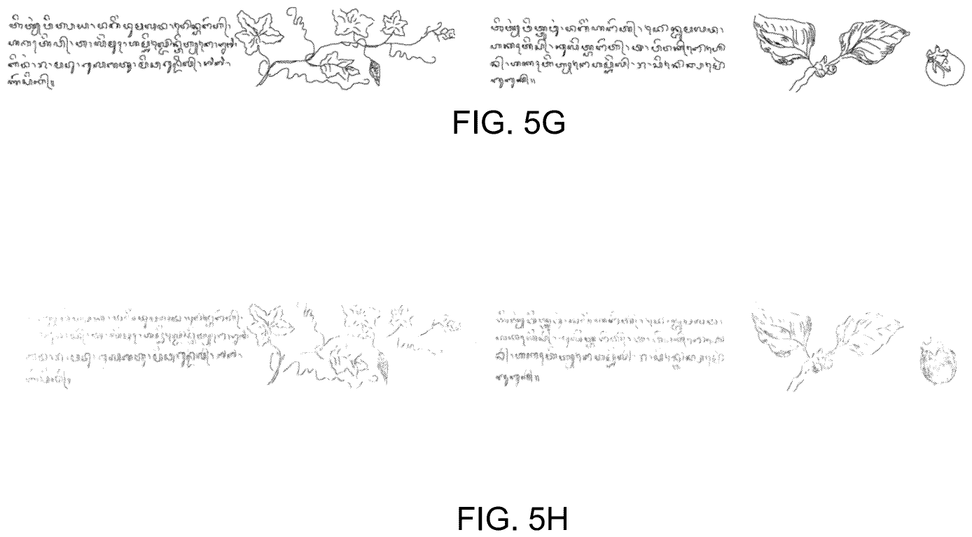

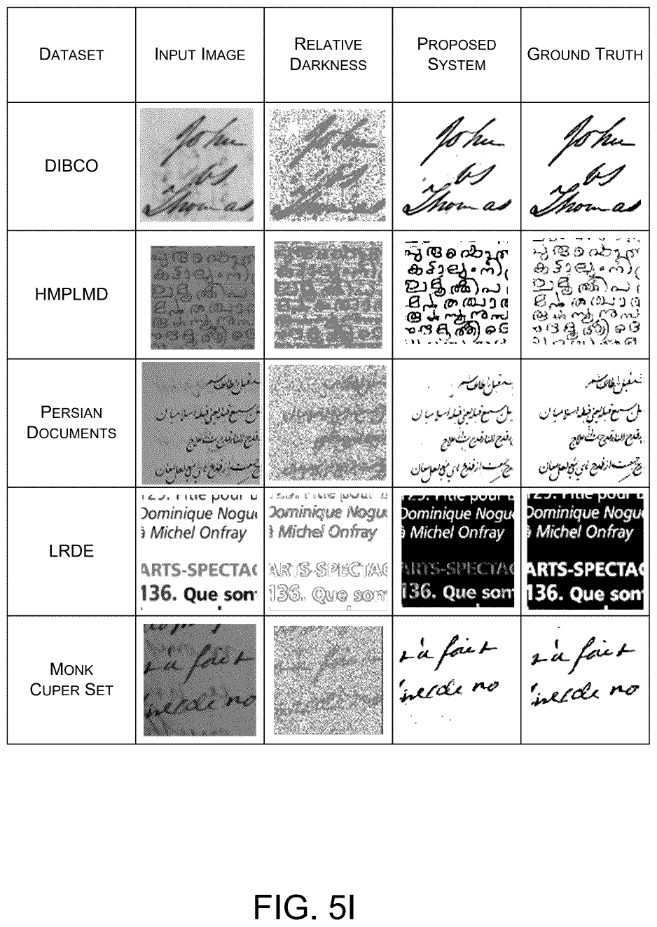

FIGS. 5A-5I illustrates a comparison of output images received from the system (200) with Ground Truth (GT) images, in accordance with embodiments of the present disclosure.

With reference to FIGS. 5A-5I, FIG. 5A illustrates the original image ‘A’, FIG. 5B illustrates the predicted image of ‘A’, FIG. 5C illustrates the GT of ‘A’, FIG. 5D illustrates the predicted image of ‘A’ without using relative darkness adjustments, FIG. 5E illustrates the original image ‘B’, FIG. 5F illustrates the predicted image of ‘B’, FIG. 5G illustrates the GT of ‘B’, and FIG. 5H illustrates the predicted image of ‘B’ without using relative darkness adjustments.

The qualitative results highlight the system's visual accuracy in binarization tasks. FIGS. 5B and 5F exhibit examples of the system's predicted output compared to the ground truth, demonstrating exact character border identification and consistent separation of foreground and background.

FIGS. 5A-5I illustrate that the proposed system achieves a more precise binarization than the model that doesn't utilize relative darkness. Character boundaries are clearly visible in the output of the proposed system. Including relative darkness along with the image for system training improves the feature learning process by providing contrast information. This method improves the system's ability to differentiate the background and foreground of the image and accurate character boundary detection. The model's generalization ability accessed by evaluating its performance using a diverse set of documents. The findings indicate that the model demonstrates excellent performance on various dataset. Accurately separating foreground and background pixels is necessary for binarization jobs, and this can be difficult due to various image features, including texture, contrast, and noise levels. However, the proposed multi modal approach achieves more precise binarization, as shown in FIG. 5I. FIG. 5I depicts performance comparison of the proposed system trained on different dataset.

Therefore, binarization of palm leaf documents may aid in their accurate digitization. The proposed system (200) binarizes the historical documents by utilizing multimodal Vision Transformer (ViT). The multimodal ViT feeds with the image and the relative darkness of the image. This additional input helps to identify the patterns and accurate binarization of the deteriorated documents. The proposed system (200) may focus on binarizing all images, including medical, scenery, portraits, and various other categories. In addition to integrating the relative darkness of the image, other types of features may also be considered using the proposed system (200).

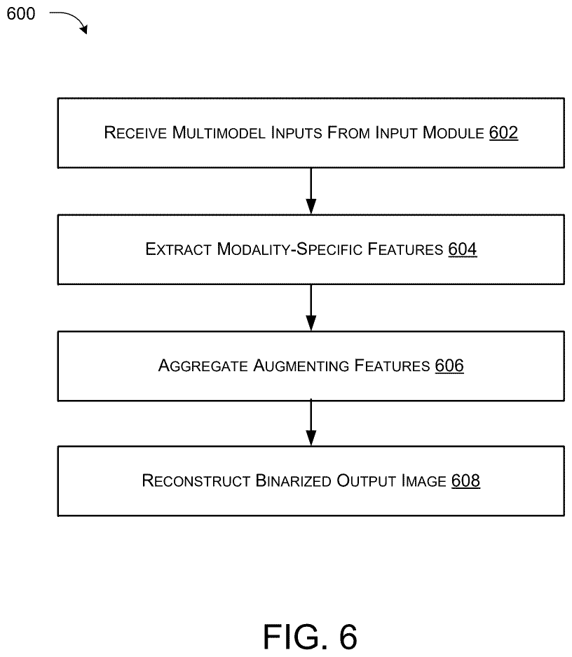

FIG. 6 illustrates a flow chart of an example method (600) for binarizing one or more images using one or more vision transformers (206a, 206b), in accordance with embodiments of the present disclosure.

The method (600) for binarizing the one or more images may be performed by the system (200) as illustrated in FIG. 2.

At 602, the method (600) may include receiving, by the encoder (204) associated with the system (200), one or more multimodal inputs including the original image and the darkness image corresponding to the original image from an input module (202). At 604, the method (600) may include discretely extracting, by the one or more vision transformers (206a, 206b), one or more modality-specific features from each of the original image and the darkness image. A t 606, the method (600) may include aggregating, by the encoder (204), one or more augmenting features among the one or more modality-specific features by determining a weighted sum of the one or more modality-specific features of each of the original image and the darkness image. At 608, the method (600) may include reconstructing, by the decoder (208) operatively connected to the encoder (204), a binarized output image corresponding to the original image by refining the one or more aggregated features.

In this application, unless specifically stated otherwise, the use of the singular includes the plural and the use of “or” means “and/or.” Furthermore, use of the terms “including” or “having” is not limiting. Any range described herein will be understood to include the endpoints and all values between the endpoints. Features of the disclosed embodiments may be combined, rearranged, omitted, etc., within the scope of the disclosure to produce additional embodiments. Furthermore, certain features may sometimes be used to advantage without a corresponding use of other features.

While the foregoing describes various embodiments of the disclosure, other and further embodiments of the disclosure may be devised without departing from the basic scope thereof. The scope of the disclosure is determined by the claims that follow. The disclosure is not limited to the described embodiments, versions, or examples, which are included to enable a person having ordinary skill in the art to make and use the disclosure when combined with information and knowledge available to the person having ordinary skill in the art.

We claim:

1. A system for binarizing one or more images using one or more vision transformers, comprising:
an encoder operatively connected to an input module, and configured to:
receive one or more multimodal inputs comprising at least an original image and a darkness image corresponding to the original image from the input module,
discretely extract, by the one or more vision transformers associated with the encoder, one or more modality-specific features from each of the original image and the darkness image, and
aggregate one or more augmenting features among the one or more modality-specific features by determining a weighted sum of the one or more modality-specific features of each of the original image and the darkness image; and
a decoder operatively connected to the encoder, and configured to:
reconstruct a binarized output image corresponding to the original image by refining the one or more aggregated features.

2. The system of claim 1, wherein the encoder is to discretely extract, by the one or more vision transformers, the one or more modality-specific features from each of the one or more multimodal inputs by being configured to:
segment both the original image and the darkness image into one or more non-overlapping patches;
transform the one or more non-overlapping patches into one or more feature vectors through patch embedding and positional embedding techniques; and
discretely extract the one or more modality-specific features from the one or more feature vectors of each of the one or more multimodal inputs using a self-attention mechanism.

3. The system of claim 1, wherein the encoder is configured to determine the weighted sum of the one or more modality-specific features based on one or more parameters.

4. The system of claim 1, wherein the encoder is to aggregate the one or more augmenting features by being configured to dynamically balance an output of each of the original image and the darkness image from each of the one or more vision transformers through pre-trainable weights.

5. The system of claim 1, wherein the encoder is configured to identify the one or more augmenting features among the one or more modality-specific features based on a dependency between the one or more non-overlapping patches.

6. The system of claim 1, wherein the encoder is to determine, by the one or more vision transformers, the dependency between the one or more non-overlapping patches by being configured to:
transform each of the one or more non-overlapping patches into one or more variables;
compare the one or more variables of each of the one or more non-overlapping patches; and
in response to the comparison, determine the dependency between the one or more non-overlapping patches, based on a similarity score, to determine attention weights of each of the one or more non-overlapping patches.

7. The system of claim 5, wherein the encoder is configured to determine, the one or more vision transformers, a correlation between the one or more non-overlapping patches based on the similarity score and the attention weights of each of the one or more non-overlapping patches.

8. The system of claim 2, wherein the decoder is to reconstruct the binarized output image corresponding to the original image by being configured to:
progressively transform the one or more feature vectors, through a combination of deconvolution, convolution, batch normalization, and activation techniques, to enhance spatial resolution and feature representation in one or more feature maps;
upon transformation, dynamically enhance one or more regions with relevant information within the one or more feature maps to suppress one or more regions with irrelevant information within the one or more feature maps by applying a spatial attention mechanism; and
reconstruct the binarized output image by further refining the one or more feature maps and the one or more aggregated features through the convolution techniques.

9. The system of claim 1, wherein the decoder is configured to reconstruct the binarized output image with a predetermined spatial resolution.

10. A method for binarizing one or more images using one or more vision transformers, comprising:
receiving, by an encoder associated with a system, one or more multimodal inputs comprising at least an original image and a darkness image corresponding to the original image from an input module;
discretely extracting, by the one or more vision transformers associated with the encoder, one or more modality-specific features from each of the original image and the darkness image;
aggregating, by the encoder, one or more augmenting features among the one or more modality-specific features by determining a weighted sum of the one or more modality-specific features of each of the original image and the darkness image; and
reconstructing, by a decoder operatively connected to the encoder, a binarized output image corresponding to the original image by refining the one or more aggregated features.

11. The method of claim 10, wherein discretely extracting, by the one or more vision transformers, the one or more modality-specific features from each of the one or more multimodal inputs comprises:
segmenting, by the one or more vision transformers, both the original image and the darkness image into one or more non-overlapping patches;
transforming, by the one or more vision transformers, the one or more non-overlapping patches into one or more feature vectors through patch embedding and positional embedding techniques; and
discretely extracting, by the one or more vision transformers, the one or more modality-specific features from the one or more feature vectors of each of the one or more multimodal inputs using a self-attention mechanism.

12. The method of claim 10, wherein determining, by the encoder, the weighted sum of the one or more modality-specific features of each of the original image and the darkness image based on one or more parameters.

13. The method of claim 10, wherein aggregating, by the encoder, the one or more augmenting features comprises dynamically balancing, by the encoder, an output of each of the original image and the darkness image from each of the one or more vision transformers through pre-trainable weights.

14. The method of claim 10, comprising identifying, by the encoder, the one or more augmenting features among the one or more modality-specific features based on a dependency between the one or more non-overlapping patches.

15. The method of claim 14, wherein determining, by the one or more vision transformers, the dependency between the one or more non-overlapping patches comprises:
transforming, by the one or more vision transformers, each of the one or more non-overlapping patches into one or more variables;
comparing, by the one or more vision transformers, the one or more variables of each of the one or more non-overlapping patches; and
in response to the comparison, determining, by the one or more vision transformers, the dependency between the one or more non-overlapping patches, based on a similarity score, to determine attention weights of each of the one or more non-overlapping patches.

16. The method of claim 15, comprising determining, the one or more vision transformers, a correlation between the one or more non-overlapping patches based on the similarity score and the attention weights of each of the one or more non-overlapping patches.

17. The method of claim 11, wherein reconstructing, by the decoder, the binarized output image corresponding to the original image comprises:
progressively transforming, by the decoder, the one or more feature vectors, through a combination of deconvolution, convolution, batch normalization, and activation techniques, to enhance spatial resolution and feature representation in one or more feature maps;
upon transformation, dynamically enhancing, by the decoder, one or more regions with relevant information within the one or more feature maps to suppress one or more regions with irrelevant information within the one or more feature maps by applying a spatial attention mechanism; and
reconstructing, by the decoder, the binarized output image by further refining the one or more feature maps and the one or more aggregated features through the convolution techniques.

18. The method of claim 10, wherein comprising reconstructing, by the decoder, the binarized output image with a predetermined spatial resolution.
